(19) United States
(12) Patent Application Publication
(10) Pub. No.: US 2006/0111265 A1
(43) Pub. Date: May 25, 2006

(54) Acidic hard surface cleaners

(75) Inventors: Ralph Edward Rypkema, Lodi, NJ (US); Maria Vieitez Koretzky, Montvale, NJ (US)

Correspondence Address: NORRIS, MCLAUGHLIN & MARCUS, 875 THIRD AVE, 18TH FLOOR, NEW YORK, NY, 10022, US

(73) Assignee: RECKITT BENCKISER INC. MORRIS CORPORATE CENTER IV, PARSIPPANY, NJ (US)

(21) Appl. No.: 10/522,276

(22) PCT Filed: Jul. 14, 2003
(86) PCT No.: PCT/GB03/03047

§ 371 Date: Nov. 15, 2005

(30) Foreign Application Priority Data
Jul. 24, 2002 (GB) 0217093.4

(51) Int. Cl. C11D 3/00

(52) U.S. Cl. 510/504

(57) ABSTRACT

Alkaline cleaning compositions for hard surfaces are described.

The present invention relates to cleaning compositions for hard surfaces.

Cleaning compositions are commercially important products and enjoy a wide field of utility in assisting in the removal of dirt and grime from surfaces, especially those characterized as useful with hard surfaces such as toilets, shower stalls, bathtubs, bidets, sinks, etc., as well as countertops, walls, floors, etc.

The present invention is directed to a composition comprising (a) at least one cationic surfactant having germicidal properties; (b) at least one nonionic surfactant; (c) a chelating agent selected from alkali metal, ammonium and substituted ammonium polyacetates, carboxylates, polycarboxylates and polyhydroxysulfonates; optionally (c1) a precipitating builder selected from the group potassium carbonate and potassium oxalate; optionally (d) an effective amount of propellant; (e) water; and (f) optional components selected from coloring agents, fragrances and fragrance solubilizers, viscosity modifying agents, pH adjusting agents and pH buffers including organic and inorganic salts, hydrotropes, anti-spotting agents, anti-oxidants, preservatives, and corrosion inhibitors.

The composition of the present invention has an alkaline pH (greater than 7) and is generally between about 12 and about 14.

One component of the present invention is at least one cationic surfactant having germicidal properties, described in, for example, McCutcheon's Detergents and Emulsifiers, North American and International Editions, 2001; Kirk-Othmer, Encyclopedia of Chemical Technology, 4th Ed., Vol. 23, pp. 478-541, the contents of which are herein incorporated by reference.

Examples of cationic surfactant compositions useful in the practice of the instant invention are those which provide a germicidal effect to the concentrate compositions, and especially preferred are quaternary ammonium compounds and salts thereof, which may be characterized by the general structural formula: 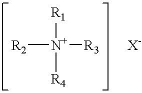
where at least one of R₁, R₂, R₃ and R₄ is an alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the above mentioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The counterion X may be any salt-forming anion which permits water solubility of the quaternary ammonium complex.

Exemplary quaternary ammonium salts within the above description include the alkyl ammonium halides such as cetyl trimethyl ammonium bromide, alkyl aryl ammonium halides such as octadecyl dimethyl benzyl ammonium bromide, N-alkyl pryridinium halides such as N-cetyl pyridinium bromide, and the like. Other suitable types of quaternary ammonium salts include those in which the molecule contains either amide, ether or ester linkages such as octyl phenoxy ethoxy ethyl dimethyl benzyl ammonium chloride, N-(laurylcocoaminoformylmethyl)-pyridinium chloride, and the like. Other very effective types of quaternary ammonium compounds which are useful as germicides include those in which the hydrophobic radical is characterized by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylphenyltrimethyl ammonium chloride, chlorinated dodecylbenzyltrimethyl ammonium chloride, and the like.

Other quaternary ammonium compounds which act as germicides and which are found to be useful in the practice of the present invention include those which have the structural formula: 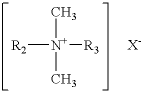
wherein R₂ and R₃ are the same or different C₈-C₁₂ alkyl, or R₂ is C₁₂₋₁₆ alkyl, C₈₋₁₈alkylethoxy, C₈₋₁₈alkylphenoxyethoxy and R₃ is benzyl, and X is a halide, for example chloride, bromide or iodide, or is a methosulfate or saccharinate anion. The alkyl groups recited in R₂ and R₃ may be straight-chained or branched, but are preferably substantially linear.

Still other quaternary germicides include compositions which include a single quaternary compound, as well as mixtures of two or more different quaternary compounds. Such useful quaternary compounds are available under the BARDAC®, BARQUAT®, HYAMINE®, CATIGENE, LONZABAC®, BTC®, and ONYXIDE® trademarks, which are more fully described in, for example, McCutcheon's Functional Materials, North American and International Editions, 2001, and the respective product literature from the suppliers identified below. For example, BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active) (also available as 80% active (BARDAC® 208M)); described generally in McCutcheon's as a combination of alkyl dimethyl benzyl ammonium chloride and dialkyl dimethyl ammonium chloride); BARDAC® 2050 is described to be a combination of octyl decyl dimethyl ammonium chloride/didecyl dimethyl ammonium chloride, and dioctyl dimethyl ammonium chloride (50% active) (also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT® MB-50, MX-50, OJ-50 (each 50% liquid) and MB-80 or MX-80 (each 80% liquid) are each described as an alkyl dimethyl benzyl ammonium chloride; BARDAC® 4250 and BARQUAT® 4250Z (each 50% active) or BARQUAT® 4280 and BARQUAT® 4280Z (each 80% active) are each described as alkyl dimethyl benzyl ammonium chloride/alkyl dimethyl ethyl benzyl ammonium chloride; and BARQUAT® MS-100 described as being Alkyl Dimethyl Benzyl Ammonium Chloride (100% solid (powder)). Also, HYAMINE® 1622, described as diisobutyl phenoxy ethoxy ethyl dimethyl benzyl ammonium chloride (available either as 100% actives or as a 50% actives solution); HYAMINE® 3500 (50% actives), described as alkyl dimethyl benzyl ammonium chloride (also available as 80% active (HYAMINE® 3500-80); and HYAMINE® 2389 described as being based on methyldodecylbenzyl ammonium chloride and/or methyldodecylxylene-bis-trimethyl ammonium chloride. (BARDAC®, BARQUAT® and HYAMINE® are presently commercially available from Lonza, Inc., Fairlawn, N.J.). BTC® 50 NF (or BTC® 65 NF) is described to be alkyl dimethyl benzyl ammonium chloride (50% active); BTC® 99 is described as didecyl dimethyl ammonium chloride (50% active); BTC® 776 is described to be myristalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC® 818-80%)); BTC® 824 and BTC® 835 are each described as being of alkyl dimethyl benzyl ammonium chloride (each 50% active); BTC® 885 is described as a combination of BTC® 835 and BTC® 818 (50% active) (available also as 80% active (BTC® 888)); BTC® 1010 is described as didecyl dimethyl ammonium chloride (50% active) (also available as 80% active (BTC® 1010-80)); BTC® 2125 (or BTC® 2125 M) is described as alkyl dimethyl benzyl ammonium chloride and alkyl dimethyl ethylbenzyl ammonium chloride (each 50% active) (also available as 80% active (BTC® 2125-80 or BTC® 2125 M)); BTC® 2565 is described as alkyl dimethyl benzyl ammonium chlorides (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). CATIGENE series is described as mixtures of alkyl dimethyl benzyl ammonium chlorides/alkyl dimethyl ethyl benzyl ammonium chlorides/dialkyl dimethyl ammonium chlorides. (BTC®, ONYXIDE®, and CATIGENE are presently commercially available from Stepan Company, Northfield, Ill. (CATIGENE from Stepan Europe)). Another cationic surfactant of interest is Rewoquat CQ100, which is reported to be a blend of a quaternary ammonium compound and an ethoxylated fatty alcohol. Polymeric quaternary ammonium salts based on these monomeric structures are also considered desirable for the present invention. One example is POLYQUAT®, described as being a 2-butenyidimethyl ammonium chloride polymer.

The amount of at least one cationic surfactant having germicidal properties, when present in the inventive composition, ranges from about 0.01 to about 10% wt.

Another component of the present invention is (b) at least one nonionic surfactant.

Nonlimiting examples of suitable nonionic surfactants which may be used in the present invention include:

(1) The polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

(2) The condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). One example of such a nonionic surfactant is available as Empilan KM 50.

(3) Alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

Other nonionic surfactants containing the characteristic alkylene oxide blocks are those which may be generally represented by the formula (A):
HO-(EO)ₓ(PO)_{y}(EO)_{z}-H (A)
where
EO represents ethylene oxide,
PO represents propylene oxide,
y equals at least 15,
(EO)_{x+y} equals 20 to 50% of the total weight of said compounds, and, the total molecular weight is preferably in the range of about 2000 to 15,000. These surfactants are available under the PLURONIC tradename from BASF or Emulgen from Kao.

Another group of nonionic surfactants can be represented by the formula (B):
R-(EO,PO)ₐ(EO,PO)_{b}-H (B)
wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further nonionic surfactants containing polymeric butoxy (BO) groups can be represented by formula (C) as follows:
RO—(BO)ₙ(EO)ₓ-H (C)
wherein
R is an alkyl group containing 1 to 20 carbon atoms,
n is about 5-15 and x is about 5-15.

Also further nonionic block copolymer surfactants, which also include polymeric butoxy groups, are those which may be represented by the following formula (D):
HO-(EO)ₓ(BO)ₙ(EO)_{y}-H (D)
wherein
n is about 5-15, preferably about 15,
x is about 5-15, preferably about 15, and
y is about 5-15, preferably about 15.

Still further nonionic block copolymer surfactants include ethoxylated derivatives of propoxylated ethylene diamine, which may be represented by the following formula: 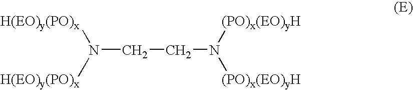
where
(EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

Other examples of non-ionic surfactants include linear alcohol ethoxylates. The linear alcohol ethoxylates which may be employed in the present invention are generally include the C₆-C₁₅ straight chain alcohols which are ethoxylated with about 1 to 13 moles of ethylene oxide.

Examples include Alfonic® 810-4.5, which is described in product literature from Sasol North America Inc. as having an average molecular weight of 356, an ethylene oxide content of about 4.85 moles (about 60 wt. %), and an HLB of about 12; Alfonic® 810-2, which is described in product literature from Sasol North America Inc. as having an average molecular weight of 242, an ethylene oxide content of about 2.1 moles (about 40 wt. %), and an HLB of about 12; and Alfonic® 610-3.5, which is described in product literature from Sasol North America Inc. as having an average molecular weight of 276, an ethylene oxide content of about 3.1 moles (about 50 wt. %), and an HLB of 10. Product literature from Sasol North America Inc. also identifies that the numbers in the alcohol ethoxylate name designate the carbon chain length (numbers before the hyphen) and the average moles of ethylene oxide (numbers after the hyphen) in the product. These examples are typically C₆-C₁₁ straight-chain alcohols which are ethoxylated with from about 3 to about 6 moles of ethylene oxide.

Other examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Another example includes a C₁₁ linear primary alcohol ethoxylate averaging about 9 moles of ethylene oxide per mole of alcohol, available, for example, under the commercial name of Neodol 1-9.

Further examples of ethoxylated alcohols include the Rhodasurf® DA series non-ionic surfactants available from Rhodia which are described to be branched isodecyl alcohol ethoxylates. Rhodasurf DA-530 has been described as having 4 moles of ethoxylation and an HLB of 10.5; Rhodasurf DA-630 has been described as having 6 moles of ethoxylation with an HLB of 12.5; and Rhodasurf DA-639 is a 90% solution of DA-630.

Further examples of ethoxylated alcohols include those from Tomah Products (Milton, Wis.) under the Tomadol tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C9/C10/C11 and n is 2.5, 6, or 8; 1-3; 1-5; 1-7; 1-73B; 1-9; —where R is linear C11 and n is 3, 5, 7 or 9; 23-1; 23-3; 23-5; 23-6.5—where R is linear C12/C13 and n is 1, 3, 5, or 6.5; 25-3; 25-7; 25-9; 25-12—where R is linear C12/C13 C14/C15 and n is 3, 7, 9, or 12; and 45-7; 45-13—where R is linear C14/C15 and n is 7 or 13.

Other examples of nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol UD series from Clariant, described as tradenames Genapol UD 030, C₁₁-Oxo-alcohol polyglycol ether with 3 EO; Genapol UD, 050 C₁₁-Oxo-alcohol polyglycol ether with 5 EO; Genapol UD 070, C₁₁-Oxo-alcohol polyglycol ether with 7 EO; Genapol UD 080, C₁₁-Oxo-alcohol polyglycol ether with 8 EO; Genapol UD 088, C₁₁-Oxo-alcohol polyglycol ether with 8 EO; and Genapol UD 110, C₁₁-Oxo-alcohol polyglycol ether with 11 EO.

Other examples include those surfactants having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename. available from Clariant, Charlotte, N.C., include the 26-L series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1, 26-L-1.6, 26-L-2, 26-L-3, 26-L-5, 26-L-45, 26-L-50, 26-L-60, 26-L-60N, 26-L-75, 26-L-80, 26-L-98N, a the 24-L series, derived from synthetic sources and typically contain about 55% C₁₂ and 45% C₁₄ alcohols, such as 24-L-3, 24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

Other examples of alcohol ethoxylates are C₁₀ oxo-alcohol ethoxylates available from BASF under the Lutensol ON tradename. They are available in grades containing from about 3 to about 11 moles of ethylene oxide (available under the names Lutensol ON 30; Lutensol ON 50; Lutensol ON 60; Lutensol ON 65; Lutensol ON 66; Lutensol ON 70; Lutensol ON 80; and Lutensol ON 110).

Another class of nonionic surfactants include amine oxide compounds which may be defined as one or more of the following of the four general classes:
(1) Alkyl di (lower alkyl) amine oxides in which the alkyl group has about 6-24, and preferably 8-18 carbon atoms, and can be straight or branched chain, saturated or unsaturated. The lower alkyl groups include between 1 and 7 carbon atoms, but preferably each include 1-3 carbon atoms. Examples include octyl dimethyl amine oxide, lauryl dimethyl amine oxide, myristyl dimethyl amine oxide, and those in which the alkyl group is a mixture of different amine oxides, such as dimethyl cocoamine oxide, dimethyl (hydrogenated tallow) amine oxide, and myristyl/palmityl dimethyl amine oxide;
(2) Alkyl di (hydroxy lower alkyl) amine oxides in which the alkyl group has about 6-22, and preferably 8-18 carbon atoms, and can be straight or branched chain, saturated or unsaturated. Examples include bis-(2-hydroxyethyl) cocoamine oxide, bis-(2-hydroxyethyl) tallowamine oxide; and bis-(2-hydroxyethyl) stearylamine oxide;
(3) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and
(4) Alkylmorpholine oxides in which the alkyl group has about 10-20, and preferably 12-16 carbon atoms, and can be straight or branched chain, saturated or unsaturated.

While these amine oxides recited above may be used, preferred are amine oxides which may be represented by the following structural representation: 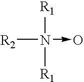
wherein
each R₁ independently is a straight chained C₁-C₄ alkyl group; and,
R₂ is a straight chained C₆-C₂₂ alkyl group or an alkylamidoalkylene having the formula 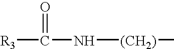
where R₃ is C₅-C₂₀ alkyl or
   —(CH₂)ₚ—OH
where n is 1 to 5 and p is 1 to 6; additionally, R2 or R3 could be ethoxylated (1 to 10 moles EO/mol) or propoxylated (1 to 10 moles of PO/mol).

Each of the alkyl groups may be linear or branched, but most preferably are linear. Examples include Ammonyx® LO which is described to be as a 30% wt. active solution of lauryl dimethyl amine oxide; Ammonyx® CDO Special, described to be a about 30% wt. active solution of cocoamidopropylamine oxide, as well as Ammonyx® MO, described to be a 30% wt. active solution of myristyidimethylamine oxide, all available from Stepan Company (Northfield, Ill.) with similar materials also available from Lonza under the Barlox trademark.

The at least one non-ionic surfactant is present in the inventive composition in an amount of from about 0.01 to about 40% wt. Examples of the non-ionic surfactant include alcohol ethoxylate and a mixture of alcohol ethoxylate and amine oxide.

Another component of the present invention is a chelate. Chelants useful herein include the various alkali metal, ammonium and substituted ammonium polyacetates, carboxylates, polycarboxylates and polyhydroxysulfonates. Non-limiting examples include the sodium, potassium, lithium, ammonium and substituted ammonium salts of ethylenediaminetetraacetic acid, ethylenediaminetriacetic acid, ethylenediaminetetrapropionic acid, diethylenetriaminepentaacetic acid, nitrilotriacetic acid, N-hydroxyethylethylenediaminetriacetic acid, oxydisuccinic acid, iminodisuccinic acid, ethylenediamine disuccinic acid, triethylenetetraaminehexaacetic acid, ethanoldiglycines, proprylenediaminetetraacetic acid, methylglycinediacetic acid, N,N,N′,N′-tetra(carboxymethyl)-2,6-diaminohexanoic acid, N,N,N′,N′ tetra(carboxymethyl)-2,5-diaminopentanoic acid, N,N,N′,N′-tetra(carboxymethyl)-2,4-diaminobutyric acid and 2-hydroxy-3-aminopropionic-N,N-diacetic acid, or a derivative thereof. These chelating agents may also exist either partially or totally in the hydrogen ion form, for example, disodium dihydrogen ethylenediaminetetraacetate. The substituted ammonium salts include those from methylamine, dimethylamine, butylamine, butylenediamine, propylamine, triethylamine, trimethylamine, monoethanolamine, diethanolamine, triethanolamine, isopropanolamine, and propanolamine. Examples include mono-, di-, tri- and tetrasodium salts of ethylenediaminetetraacetic acid; mono-, di-, tri- and tetrapotassium salts of ethylenediaminetetraacetic acid; tetraammonium salt of ethylenediaminetetraacetic acid; disodium ethanoldiglycinate; mono-, di-, and tetrasodium ethylenediaminedisuccinate; as well as those mentioned herein.

The sodium salts of ethylenediaminetetraacetic acid are readily available. The potassium salts of ethylenediaminetetraacetic acid can be made by taking the acid form of ethylenediaminetetraacetic acid and neutralizing or partially neutralizing it with potassium hydroxide. For example, tetrapotassium ethylenediaminetetraacetate can be prepared by taking ethylenediaminetetraacetic acid and neutralizing it with potassium hydroxide in a stoichiometric quantity. For example, to 50 g of ethylenediaminetetraacetic acid and 47 g deionized water, 76 g of potassium hydroxide solution (45%) can be slowly added, resulting in a 46% tetrapotassium ethylenediaminetetraacetic acid salt solution. In the neutralization of ethylenediaminetetraacetic acid, it is preferred to use an excess of alkali. Thus, for example, the level of potassium hydroxide can vary from a stoichiometric quantity to from about a 0 to 5% excess. The incompletely neutralized mono-, di-, or tripotassium ethylenediaminetetraacetic acid salts can be prepared by taking ethylenediaminetetraacetic acid and neutralizing it with potassium hydroxide in a less than stoichiometric quantity. For example, to 7 g of ethylenediaminetetraacetic acid and 79.3 g deionized water, 2.1 g of potassium hydroxide solution (45%) can be slowly added, resulting in a 52% tripotassium ethylenediaminetetraacetic acid salt solution. In the neutralization of ethylenediaminetetraacetic acid, it is preferred to use less than a stoichiometric amount of alkali.

Another example of a chelate for use in the present invention is ethylenediamine-N,N′-disuccinic acid (EDDS), the alkali metal, alkaline earth metal, ammonium, or substituted ammonium salts thereof, or mixtures thereof. Examples of sodium salts of EDDS include NaEDDS, Na₂EDDS and Na₄EDDS.

Methods of synthesizing EDDS are known in the art. For example, U.S. Pat. No. 3,158,635, to Kezerian and Ramsey, issued Nov. 24, 1964, discloses methods of preparing compounds having the formula: 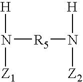
wherein Z₁ and Z₂ are the same or different bis-adduction residues of unsaturated polycarboxylic acids and salts thereof, and R₅ is an alkylene or alkylene-phenylene group. These compounds are taught to be useful for removing rust and oxide coating from metals. If 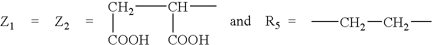
then the compound is EDDS. EDDS can be synthesized, for example, from readily available, inexpensive starting materials, such as maleic anhydride and ethylenediamine, as follows: 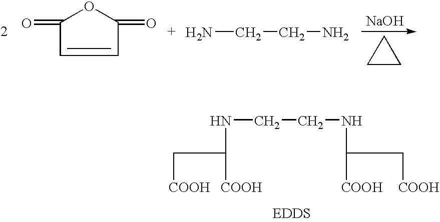
Springer and Kopecka, Chem. Zvesti. 20(6): 414-422 (1966) (CAS abstract 65:11738f), discloses a method for synthesizing EDDS and describes the formation of EDDS complexes with heavy metals. Stability constants were determined for the complexes of EDDS with Cu²⁺, Co³⁺, Ni²⁺, Fe³⁺, Pb²⁺, Zn²⁺, and Cd²⁺.

Pavelcik and Majer, Chem. Zvesti. 32(1): 37-41 (1978) (CAS abstract 91(5): 38875f), describes the preparation and properties of the meso and racemate stereoisomer forms of EDDS. The meso and racemate forms were separated via their Cu(II) complexes, with the racemate form being identified from crystallographic data. These compounds are taught to be useful as selective analytical titration agents.

A more complete disclosure of methods for synthesizing EDDS from commercially available starting materials can be found in U.S. Pat. No. 3,158,635, Kezerian and Ramsey, issued Nov. 24, 1964 as well as in U.S. Pat. No. 4,704,233, Hartman and Perkins, issued Nov. 3, 1987 and U.S. Pat. No. 6,414,189, Banba, Tanaka, Niwa, and Endo, issued Jul. 2, 2002, incorporated herein by reference.

The synthesis of EDDS from maleic anhydride and ethylenediamine yields a mixture of three optical isomers, [R,R], [S,S], and [S,R], due to the two asymmetric carbon atoms.

The biodegradation of EDDS appears to be optical isomer-specific, with the [S,S] isomer degrading most rapidly and extensively.

The [S,S] isomer of EDDS can be synthesized from L-aspartic acid and 1,2-dibromethane, as follows:

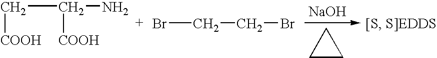

A more complete disclosure of the reaction of L-aspartic acid with 1,2-dibromethane to form the [S,S] isomer of EDDS can be found in Neal and Rose, Stereospecific Ligands and Their Complexes of Ethylenediamine-disuccinic Acid, Inorganic Chemistry, Vol. 7. (1968), pp. 2405-2412, incorporated herein by reference.

Another example of a chelate for use in the present invention is 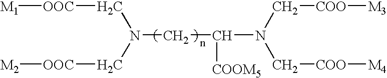
wherein n represents a number from 1 to 6, each of M¹, M², M³, M⁴ and M⁵ independently represent: a hydrogen atom, an alkali metal, an ammonium group an ammonium group substituted by 1 to 4 organic groups. Preferably, each of M¹, M², M³, M⁴ and M⁵ independently represent a hydrogen atom, a sodium or potassium atom, an ammonium group a monoalkylammonium, dialkylammonium, trialkylammonium or tetraalkylammonium group, the alkyl radical or radicals, linear or branched, having 1 to 4 carbon atoms and more preferably, n represents a number from 2 to 4, each of M¹, M², M³, M⁴ and M⁵ independently represent a hydrogen atom or a sodium atom. pentasodium or tetrasodium salts of N,N,N′,N′-tetra(carboxymethyl)-2,6-diaminohexanoic acid, the pentasodium or tetrasodium salts of N,N,N′,N′ tetra (carboxymethyl)-2,5-diaminopentanoic acid, the pentasodium or tetrasodium salts of N,N,N′,N′-tetra(carboxymethyl)-2,4-diaminobutyric acid.

These chelates are described in GB2261218. As provided for therein, these chelates can be obtained in particular from diaminocarboxylic acids having the formula: 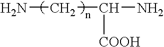
in which n represents a number from 1 to 6 and preferably from 2 to 4, by reaction with sodium chloroacetate.

Generally, the reaction is carried out in solution in water and at a temperature of 25° C. to 100° C. and preferably 40° C. to 90° C. without these values having a critical importance.

Among the diaminocarboxylic acids of above formula, lysine (n=4) is very particularly advantageous because of its relatively low cost. Ornithine (n=3) and 2,4-diaminobutyric acid (n=2) may also be mentioned.

Another process for preparing these chelates consists in reacting diaminocarboxylic acid with an alkali metal cyanide and formaldehyde.

This reaction is normally carried out in water, in a water-miscible solvent or in a mixture of water and such a solvent, at a temperature of 25° C. to 100° C. and preferably 40° C. to 90° C. If water is present during the reaction then the chelates may be formed directly by this reaction. If water is not present and the solvent is e.g. a water-miscible solvent, then a nitrile compound is produced, which is then hydrolysed to give the desired compound. The hydrolysis may be carried out in situ or after isolation of the nitrile compound.

The following examples illustrate the preparation of these chelates (taken from GB2261218 (pages 11 to 13 thereof):

### EXAMPLE 1

Preparation of the pentasodium salt of N,N,N′,N′ tetra(carboxvmethvl)-2,6-diaminohexanoic acid

146 g (1 mol) of lysine were dissolved in 400 g of water and the solution obtained was heated to 65° C.

480 g (4.12 mol) of sodium chloroacetate were added in portions in 1 hour with stirring.

600 g of an aqueous solution containing 27% by weight of sodium hydroxide (4.05 mol of NaOH) were then progressively added at a rate enabling the pH to be maintained between 8.8 and 9.2. During the addition of sodium hydroxide, the temperature was allowed to rise up to a maximum of 85° C.

At the end of the addition, the reaction mixture was again stirred for 2 hours at 88° C. and then the temperature was raised to the reflux temperature for 30 minutes.

The reaction mixture was allowed to cool to room temperature; sodium chloride precipitated during this cooling. Next, the mixture was filtered at room temperature.

The filtrate was allowed to stand overnight and another amount of sodium chloride then precipitated.

After another filtration, the filtrate was diluted with 1500 g of water, it was then acidified to about pH 1 with 800 g of hydrochloric acid at 36% by weight.

After inoculation by seeding, the crystallisation occurred slowly. After allowing to stand overnight, the product was filtered, washed abundantly with water and finally suspended in 1000 g of water and heated with stirring at 80° C.

After cooling, the solid was filtered and dried at 80° C. under vacuum.

250 g of N,N,N′,N′-tetra(carboxymethyl)-2,6-diaminohexanoic acid with a melting point of 216-220° C. were thus obtained (yield of 66% relative to the lysine used).

The corresponding pentasodium salt is easily prepared by neutralising the different carboxylic functional groups by means of a solution of sodium hydroxide.

### EXAMPLE 2

305.5 g of lysine was dissolved in 600 mls of water and, 161.2 g of 100 TW (47%) sodium hydroxide solution, and 10.8 g of sodium cyanide solution (30%) were then added.

The contents of the flask were heated to 67° C.-70° C., and sodium cyanide solution (1572 g) and formaldehyde solution (929.2 g) were then added continuously over a period of 5.5 hours via peristaltic pumps.

During the early stages of the addition an exotherm produced by the reaction of the cyanide and formaldehyde was sufficient to bring the temperature of the reaction mixture to 97° C.-98° C. The bulk of the addition was carried out at the boiling point at atmospheric pressure.

After all the cyanide had been added, the formaldehyde addition was stopped and the cyanide level of the reaction mixture was checked and found to be 3050 ppm.

This level was reduced to below 3 ppm by addition of formaldehyde (to a total of 929.2 g) Throughout the addition, ammonia solution was distilled from the reaction and a total of 1610 ml was collected.

The weight of solution remaining at the end of all additions was 1700 g with an initial N,N,N′,N′-tetra(carboxymethyl)-2,6-diaminohexanoic acid [Lysta] content of 44%. This was diluted to give a solution of nominally 30% Lysta (Acid).

Final Weight 2636 g

Final Assay 29.6% Lysta (Acid)

Another chelate useful in the present invention includes 2-hydroxy-3-aminopropionic-N,N-diacetic acid, or a derivative thereof, having the formula 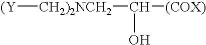
where Y is a —COOH radical, which may be present in the form of an alkali metal, ammonium or substituted ammonium salt, a —COOR¹ radical where R¹ is alkyl of 1 to 4 carbon atoms, or a —CN radical, and X is hydroxyl, in which case the then resulting carboxyl may be present in the form of an alkali metal, ammonium or substituted ammonium salt, an —OR² radical where R² is alkyl of 1 to 4 carbon atoms, or an —NR³R⁴ radical where R³ and R⁴ are identical or different and each is hydrogen or alkyl of 1 to 4 carbon atoms, which, in the form of the free acid or in particular as sodium, potassium, ammonium or organic amine salts. These chelates are described in U.S. Pat. No. 4,827,014, the contents of which are incorporated by reference herein.

The chelating agent is present in the composition of the present invention in amounts of from about 0.5 to about 15 wt %.

The incompletely neutralized ethylenediaminetetraacetate salts (for example, mono-, di-, and tri sodium or potassium) may have enhanced properties when used in conjunction with a precipitating co-builder, most preferably either potassium carbonate, K₂CO₃, or potassium oxalate, K₂C₂O₄. When used, the precipitating co-builder is present in an amount of from about 0.01 to about 5 wt %.

The compositions are largely aqueous in nature, and comprises as the balance of the composition water in to order to provide to 100% by weight of the compositions of the invention. The water may be tap water, but is preferably distilled and is most preferably deionized water. If the water is tap water, it is preferably substantially free of any undesirable impurities such as organics or inorganics, especially minerals salts which are present in hard water which may thus undesirably interfere with the operation of the constituents present in the aqueous compositions according to the invention.

The composition of the present invention can optionally comprise one or more constituents selected from coloring agents, fragrances and fragrance solubilizers, viscosity modifying agents, other surfactants, pH adjusting agents and pH buffers including organic and inorganic salts, optical brighteners, opacifying agents, hydrotropes, antifoaming agents, enzymes, anti-spotting agents, anti-oxidants, preservatives, and corrosion inhibitors. The use and selection of these constituents is well known to those of ordinary skill in the art.

The compositions of the invention may optionally contain conventional propellants for dispensing as aerosols from conventional pressurized containers. Propellants which may be used are well known and conventional in the art and include, for example, a hydrocarbon, of from 1 to 10 carbon atoms, such as n-propane, n-butane, isobutane, n-pentane, isopentane, and mixtures thereof; dimethyl ether and blends thereof as well as individual or mixtures of chloro-, chlorofluoro- and/or fluorohydrocarbons- and/or hydrochlorofluorocarbons (HCFCs). Useful commercially available compositions include A-70 (Aerosol compositions with a vapor pressure of 70 psig available from companies such as Diversified and Aeropress) and Dymel 152a (1,1-difluoroethane from DuPont). Compressed gases such as carbon dioxide, compressed air, nitrogen, and possibly dense or supercritical fluids may also be used.

The amount of propellant employed should provide a suitable spray pattern and for essentially complete expulsion of the composition from the aerosol container. The appropriate amount to be used for any particular aerosol propellant system can readily be determined by one skilled in the art. Preferably, the propellants comprise about 1% to about 50% of the aerosol formulation with preferred amounts being from about 2% to about 25%, more preferably from about 5% to about 15%. Generally speaking, the amount of a particular propellant employed should provide an internal pressure of from about 20 to about 150 psig at 70 F.

The benefits of the compositions described in this specification include particularly: good removal of hard water stains, good removal of soap scum stains, relatively low toxicity, as well as ease in handling of the composition due to its readily pourable or pumpable characteristic, and when needed, disinfection. Further, when one or more of the optional constituents is added, i.e., fragrance and/or coloring agents, the esthetic and consumer appeal of the product is favorably improved.

The compositions according to the invention are useful in the cleaning and/or disinfecting of hard surfaces, having deposited soil thereon. In such a process, cleaning and disinfecting of such surfaces comprises the step of applying a stain releasing and disinfecting effective amount of a composition as taught herein to such a stained surface. Afterwards, the compositions are optionally but desirably wiped, scrubbed or otherwise physically contacted with the hard surface, and further optionally, may be subsequently rinsed from the surface.

The cleaning compositions of this invention can be supplied in self-contained valve controlled aerosol units which provide a fine spray or foam upon activation of the valve. The aerosol container unit consists of a pressure-tight aerosol container having a valve control opening and containing the cleaning composition of this invention and an amount of a propellant as mentioned above.

The hard surface cleaner composition provided according to the invention can also be provided as a ready to use product in a pourable, manually squeezed bottle (deformable bottle), or spray bottle which uses a dip tube and trigger assembly to dispense a liquid. In such an application, the consumer generally applies an effective amount of the cleaning composition and within a few moments thereafter, wipes off the treated area with a rag, towel, brush or sponge, usually a disposable paper towel or sponge. In certain applications, however, especially where undesirable stain deposits are heavy, the cleaning composition according to the invention may be left on the stained area until it has effectively loosened the stain deposits after which it may then be wiped off, rinsed off, or otherwise removed. For particularly heavy deposits of such undesired stains, multiple applications may also be used.

The following examples below illustrate exemplary formulations and preferred formulations of the inventive composition. It is to be understood that these examples are presented by means of illustration only and that further useful formulations fall within the scope of this invention and the claims may be readily produced by one skilled in the art and not deviate from the scope and spirit of the invention. Throughout this specification and in the accompanying claims, weight percents of any constituent are to be understood as the weight percent of the active portion of the referenced constituent, unless otherwise indicated.

### EXAMPLE FORMULATIONS

Exemplary formulations illustrating certain preferred embodiments of the inventive compositions and described in more detail in Table I below were formulated generally in accordance with the following protocol.

Into a suitably sized vessel, a measured amount of water was provided after which the constituents were added in the following sequence: thickening agents, surfactant, acid and then the remaining constituents. Mixing, which generally lasted from 5 minutes to 120 minutes was maintained until the particular formulation appeared to be homogeneous. The exemplary compositions were readily pourable, and retained well mixed characteristics (i.e., stable mixtures) upon standing. The constituents may be added in any order.

Examples of inventive formulations are shown in Table 1 below. The amounts added are “as is” and the active amounts are 100% unless otherwise identified.

TABLE 1

| Component | Ex. 1 | Ex. 2 | Ex. 3 | Ex. 4 | Ex. 5 | Ex. 6 |
|---|---|---|---|---|---|---|
| DI water | 86.109 | 89.530 | 86.139 | 89.428 | 89.499 | 89.529 |
| Dissolvine EDG | 13.000 | | 12.500 | 9.211 | | |
| Versene 100LN | | 9.579 | | | | |
| Trilon M | | | | | 9.100 | 9.100 |
| Alfonic 810-4.5 | 0.090 | 0.090 | | | | |
| Genapol UD-070 | | | 0.560 | 0.560 | 0.300 | |
| Genapol 26-L-80 | | | | | | 0.270 |
| Ammonyx LO | | | | | 0.300 | 0.300 |
| NaOH | 0.426 | 0.426 | 0.426 | 0.426 | 0.426 | 0.426 |
| BTC 818 | 0.230 | 0.230 | 0.230 | 0.230 | 0.230 | 0.230 |
| Sodium molybdate crystals | 0.100 | 0.100 | 0.100 | 0.100 | 0.100 | 0.100 |
| Ammonium hydroxide | 0.045 | 0.045 | 0.045 | 0.045 | 0.045 | 0.045 |
| Component | Ex. 7 | Ex. 8 | Ex. 9 | Ex. 10 | Ex. 11 | Ex. 12 |
| DI water | 89.320 | 82.829 | 82.829 | 85.899 | 78.629 | 84.729 |
| Dissolvine EDG | | 16.070 | 16.070 | 13.000 | 16.300 | 10.200 |
| Versene 100LN | 9.579 | | | | | |
| Ammonyx CDO Special | | | | | 1.720 | 1.720 |
| Ammonyx LO | 0.300 | 0.300 | | 0.300 | 0.300 | 0.300 |
| Genapol UD-070 | | | 0.300 | | | |
| Na₂CO₃ anhydrous | | | | | 2.250 | 2.250 |
| NaOH | 0.426 | 0.426 | 0.426 | 0.426 | 0.426 | 0.426 |
| BTC 818 | 0.230 | 0.230 | 0.230 | 0.230 | 0.230 | 0.230 |
| Sodium molybdate crystals | 0.100 | 0.100 | 0.100 | 0.100 | 0.100 | 0.100 |
| Ammonium hydroxide | 0.045 | 0.045 | 0.045 | 0.045 | 0.045 | 0.045 |
| Component | Ex. 13 | Ex. 14 | Ex. 15 | Ex. 16 | Ex. 17 | Ex. 18 |
| DI water | 82.569 | 82.829 | 82.829 | 78.929 | 85.599 | 85.629 |
| Dissolvine EDG | 16.070 | 16.070 | 16.070 | 16.300 | 13.000 | 13.000 |
| Ammonyx CDO Special | | | | 1.720 | | |
| Ammonyx LO | | 0.300 | | | 0.300 | 0.300 |
| Genapol 26-L-80 | | | | | | 0.270 |
| Genapol UD-070 | 0.560 | | 0.300 | | 0.300 | |
| Na₂CO₃ anhydrous | | | | 2.250 | | |
| NaOH | 0.426 | 0.426 | 0.426 | 0.426 | 0.426 | 0.426 |
| BTC 818 | 0.230 | 0.230 | 0.230 | 0.230 | 0.230 | 0.230 |
| Sodium molybdate crystals | 0.100 | 0.100 | 0.100 | 0.100 | 0.100 | 0.100 |
| Ammonium hydroxide | 0.045 | 0.045 | 0.045 | 0.045 | 0.045 | 0.045 |

| Component | Ex. 19 | Ex. 20 | Ex. 21 | Ex. 22 | Ex. 23 | Ex. 25 | Ex. 26 |
|---|---|---|---|---|---|---|---|
| DI water | 85.699 | 89.499 | 89.529 | 89.599 | 89.320 | 86.019 | 86.109 |
| Dissolvine EDG | 13.000 | | | | | 13.000 | 13.000 |
| Trilon M | | 9.100 | 9.100 | 9.100 | | | |
| Versene 100LN | | | | | 9.579 | | |
| Ammonyx LO | | 0.300 | 0.300 | | 0.300 | | |
| Genapol 26-L-80 | 0.500 | | 0.270 | 0.500 | | | 0.090 |
| Alfonic 810-4.5 | | | | | | | |
| APG 325N | | | | | | 0.180 | |
| Genapol UD-070 | | 0.300 | | | | | |
| NaOH | 0.426 | 0.426 | 0.426 | 0.426 | 0.426 | 0.426 | 0.426 |
| BTC 818 | 0.230 | 0.230 | 0.230 | 0.230 | 0.230 | 0.230 | 0.230 |
| Sodium molybdate crystals | 0.100 | 0.100 | 0.100 | 0.100 | 0.100 | 0.100 | 0.100 |
| Ammonium hydroxide | 0.045 | 0.045 | 0.045 | 0.045 | 0.045 | 0.045 | 0.045 |

TABLE 2

| | |
|---|---|
| DI water | Deionized water |
| Dissolvine EDG | Ethanoldiglycinate disodium salt (28% active; |
| | Chemplex Chemicals) |
| Versene 100LN | Ethylenediaminetetraacetic acid tetrasodium |
| | salt (38% active; Dow Chemical) |
| Trilon M | Methylglycinediacetic acid disodium salt (40% |
| | active; BASF) |
| Alfonic 810-4.5 | C₈-C₁₀ alcohol ethoxylate with 4.5 mol EO |
| | (100% active; Sasol) |
| Genapol UD-070 | Undecyl alcohol condensed with 7 mol EO |
| | (90% active; Clariant) |
| Genapol 26-L-80 | C₁₂-C₁₆ alcohol ethoxylate having a cloud |
| | point of ˜80° C. (1% solution; 100% active; |
| | Clariant) |
| BTC 818 | Dialkyl dimethyl ammonium chloride (C₈/C₁₀; 50% |
| | active; Stepan) |
| Ammonyx CDO | Cocamido propyl dimethyl amine oxide (30% |
| Special | active; Stepan) |
| Ammonyx LO | Lauryl dimethyl amino oxide (30% active; |
| | Stepan) |
| APG 325N | Alkyl polyglycoside (% active; Clariant) |
| Na₂CO₃ anhydrous | Anhydrous sodium carbonate |
| NaOH | Sodium hydroxide |
| Sodium molybdate | Sodium molybdate |
| crystals | |
| Ammonium | Ammonium hydroxide (28% active) |
| hydroxide | |

Any of the above compositions can be used as is from a trigger type spray container or can be charged into a suitable aerosol container and charged with a propellant as described above.

Several of the exemplified compositions were tested for soap scum cleaning efficacy under a modified CSMA (Chemical Specialty Manufacturer Association) test method DCC-16, “Scrubber Test for Measuring the Removal of Lime Soap”, published in CSMA Detergents Division Test Methods Compendium, pp 1-51-55 (3ed. 1995), pertinent portions of which are hereby incorporated by reference.

The substrate, black ceramic tiles (4 in.×4 in.) were washed with isopropanol using a paper towel and allowed to dry at room temperature, at least overnight.

A parent soil was prepared according the following recipe:

| Bar soap | 3.90% W/W |
|---|---|
| Shampoo | 0.35 |
| Clay | 0.06 |
| Artificial sebum | 0.15 |
| Hard water | 95.54 |

The bar soap is shaved into a suitable beaker. The remainder of the soil components were added in the above order and stirred with three-blade propeller mixer. The mixture was warmed to 45-50° C. and mixed until a smooth, lump-free suspension is achieved (approximately two hours with moderate agitation). The suspension was filtered through a Buchner funnel fitted with Whatman #1 filter paper or equivalent. The filtrate was resuspended in clean, deionized water, using the same amount of water used to make the soil, and filtered again. The resulting filtrate cake was broken up and stored in a closed container.

The reconstituted soil was made according to the following recipe:

| Parent Soil | 4.50% w/w |
|---|---|
| Hard water* | 9.00 |
| Hydrochloric acid(0.1 N) | 0.77 |
| Acetone | 85.73 |

*Hard water: deionized water with 2:1 calcium:magnesium, added to give 20,000 ppm total hardness as CaCO₃.

The above ingredients are combined in a suitable beaker. The hard water is added to the acetone, followed by the soil. This was mixed until uniform, and then the acid was added. The suspension was homogenized until color turned from white to grey (about 20-30 minutes); the beaker covered to avoid excessive solvent loss. An appropriate amount of soil was loaded into the artist's airbrush with swirling to ensure soil uniformity while loading. The airbrush should be set to an air pressure of 40 psi.

A uniform amount (0.10-0.15 g) of soil was sprayed onto the tiles. Maintain a uniform soil suspension during application by continuous brush motion and/or swirling of the suspension. The tiles were allowed to air dry (about 30 minutes) and then were placed in an oven set to approximately 205° C. for 30 minutes to melt the soil. The tiles are removed and allowed to cool before testing

A scrubber (e.g., sponge) is tared, dampened uniformly with water and squeezed until all but 17.5.+−.0.5 gm water remains in the sponge. It is then installed into a scrubber head of a Gardner Neotec or equivalent.

Approximately 2 grams of test composition is sprayed from an appropriate aerosol container onto the soiled area of one tile and allowed to stand 30 seconds on the soil. The scrubber is allowed to pass across the tile twelve times (6 cycles). The tiles are rinsed with tap water and blown dry with an air stream to eliminate water spots.

The tiles are evaluated using data acquired from a reflectometer. The percent cleaning efficiency of the test products is calculated using the following equation:
% Cleaning Efficiency=100×(RC−RS)/(RO−RS)
where
RC is reflectance of the cleaned tile
RO is reflectance of original (unsoiled) tile
RS is reflectance of soiled tile

Sixteen readings per tile were taken.

The results of the cleaning test are found in Table 3

TABLE 3

| Example # | Average Reflectance |
|---|---|
| Ex. 1 | 55.2** |
| Ex. 3 | 46.5 |
| Ex. 5 | 52.5 |
| Ex. 6 | 46.6 |
| Ex. 7 | 50.1 |
| Ex. 8 | 62.6 |
| Ex. 9 | 50.1 |
| Ex. 10 | 52.7 |
| Ex. 11 | 42.0 |
| Ex. 12 | 37.1 |
| Ex. 13 | 55.0 |
| Ex. 14 | 59.9 |
| Ex. 15 | 54.6 |
| Ex. 16 | 46.0 |
| Ex. 17 | 50.3 |
| Ex. 18 | 50.0 |
| Ex. 19 | 45.1 |
| Ex. 20 | 51.9 |
| Ex. 21 | 52.1 |
| Ex. 22 | 49.0 |
| Ex. 23 | 58.8 |
| Ex. 24 | 52.2 |
| Ex. 25 | 50.7 |

**(average of two different tests)

1. A composition comprising
(a) at least one cationic surfactant having germicidal properties;
(b) at least one nonionic surfactant;
(c) a chelating agent selected from the group alkali metal, ammonium and substituted ammonium polyacetates, carboxylates, polycarboxylates and polyhydroxysulfonates;
optionally (c1) a precipitating builder selected from the group potassium carbonate and potassium oxalate;
optionally (d) an effective amount of propellant;
(e) water; and
(f) one or more optional components selected from coloring agents, fragrances and fragrance solubilizers, viscosity modifying agents, pH adjusting agents and pH buffers including organic and inorganic salts, hydrotropes, anti-spotting agents, anti-oxidants, preservatives, and corrosion inhibitors.

2. The composition according to claim 1 wherein the nonionic surfactant is an alcohol ethoxylate.

3. The composition according to claim 1 wherein the nonionic surfactant is a mixture of alcohol ethoxylate and amine oxide.

4. The compositions according to wherein the (c) chelating agent is selected from sodium, potassium, lithium, ammonium and substituted ammonium salts of ethylenediaminetetraacetic acid, ethylenediaminetriacetic acid, ethylenediaminetetrapropionic acid, diethylenetriaminepentaacetic acid, nitrilotriacetic acid, N-hydroxyethylethylenediaminetriacetic acid, oxydisuccinic acid, iminodisuccinic acid, ethylenediamine disuccinic acid, triethylenetetraaminehexaacetic acid, ethanoldiglycines, proprylenediaminetetraacetic acid, methylglycinediacetic acid, N,N,N′,N′-tetra(carboxymethyl)-2,6-diaminohexanoic acid, N,N,N′,N′ tetra(carboxymethyl)-2,5-diaminopentanoic acid, N,N,N′,N′-tetra(carboxymethyl)-2,4-diaminobutyric acid and 2-hydroxy-3-aminopropionic-N,N-diacetic acid, or a derivative thereof.

5. The compositions according to claim 1 wherein (c) chelating agent is selected from disodium ethanoldiglycinate and tetrasodium salt of ethylenediaminetetraacetic acid.

6. The compositions according to claim 1 which contain a propellant.

7. A composition comprising
(a) at least one cationic surfactant having germicidal properties;
(b) a nonionic surfactant mixture comprising alcohol ethoxylate and amine oxide;
(c) a chelating agent selected from the group alkali metal, ammonium and substituted ammonium polyacetates, carboxylates, polycarboxylates and polyhydroxysulfonates;
optionally (c1) a precipitating builder selected from the group potassium carbonate and potassium oxalate;
optionally (d) an effective amount of propellant;
(e) water; and
(f) one or more optional components selected from coloring agents, fragrances and fragrance solubilizers, viscosity modifying agents, pH adjusting agents and pH buffers including organic and inorganic salts, hydrotropes, anti-spotting agents, anti-oxidants, preservatives, and corrosion inhibitors.

8. The compositions according to claim 7 wherein the (c) chelating agent is selected from sodium, potassium, lithium, ammonium and substituted ammonium salts of ethylenediaminetetraacetic acid, ethylenediaminetriacetic acid, ethylenediaminetetrapropionic acid, diethylenetriaminepentaacetic acid, nitrilotriacetic acid, N-hydroxyethylethylenediaminetriacetic acid, oxydisuccinic acid, iminodisuccinic acid, ethylenediamine disuccinic acid, triethylenetetraaminehexaacetic acid, ethanoldiglycines, proprylenediaminetetraacetic acid, methylglycinediacetic acid, N,N,N′,N′-tetra(carboxymethyl)-2,6-diaminohexanoic acid, N,N,N′,N′ tetra(carboxymethyl)-2,5-diaminopentanoic acid, N,N,N′,N′-tetra(carboxymethyl)-2,4-diaminobutyric acid and 2-hydroxy-3-aminopropionic-N,N-diacetic acid, or a derivative thereof.

9. The compositions according to claim 8 wherein (c) chelating agent is selected from disodium ethanoldiglycinate and tetrasodium salt of ethylenediaminetetraacetic acid.

10. The compositions according to claim 7 which contain a propellant.

11. (canceled)

12. A process for the removal of stains from hard surfaces which comprises the step of applying an effective amount of the composition according to claim 1 to a hard surface needing such treatment.
